(19) United States
(12) Patent Application Publication
(10) Pub. No.: US 2026/0121092 A1
(43) Pub. Date: Apr. 30, 2026

(54) Fuel Cell Apparatus

(71) Applicants: Hyundai Motor Company, Seoul (KR); Kia Corporation, Seoul (KR)

(72) Inventors: Hyo Sub Shim, Hwaseong-Si (KR); Sang Hyeok Nam, Hwaseong-Si (KR)

(21) Appl. No.: 19/173,384

(22) Filed: Apr. 8, 2025

(30) Foreign Application Priority Data
Oct. 28, 2024 (KR) 10-2024-0148584

(51) Int. Cl. H01M 8/04537; G01B 7/31; H01M 8/04082; H01M 8/04089

(52) U.S. Cl. CPC H01M 8/04574; G01B 7/31; H01M 8/04097; H01M 8/04201

(57) ABSTRACT

A fuel cell apparatus includes a cell stack including a plurality of unit cells stacked one above another, an ejector including a nozzle configured to eject hydrogen to an anode of the cell stack and a diffuser disposed between the nozzle and the anode, a first contact part disposed adjacent to the nozzle so as to face the diffuser, a second contact part disposed at the diffuser so as to face the nozzle, and a concentricity analysis unit configured to inspect a degree of contact (e.g., contact or non-contact) between the first contact part and the second contact part and to determine, based on a result of inspection, whether the nozzle and the diffuser are concentric with each other.

### CROSS REFERENCE TO RELATED APPLICATION

This application claims the benefit of Korean Patent Application No. 10-2024-0148584, filed on Oct. 28, 2024, which is hereby incorporated by reference as if fully set forth herein.

### TECHNICAL FIELD

The present disclosure relates to a fuel cell apparatus.

### BACKGROUND

A hydrogen supply system may include an ejector, comprising a nozzle and a diffuser, for recirculation of hydrogen. Excellent suction performance of the ejector may be achieved if the nozzle and the diffuser are concentrically disposed. However, if the nozzle and the diffuser are coupled to each other, it is difficult/impossible to check the concentricity of the nozzle and the diffuser when they are coupled to each other because the coupling portion therebetween is not exposed to the outside. Thus, there is a problem of having to cut out a part of the diffuser in order to check the concentricity between the nozzle and the diffuser. It may not be possible or suitable to cut the diffuser when supplying components to check the concentricity of the nozzle and the diffuser.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

Systems, apparatuses, and methods are described for a fuel cell apparatus and/or ejector for a fuel cell. A fuel cell apparatus may comprise a cell stack comprising a plurality of unit cells; an ejector comprising: a nozzle configured to eject hydrogen to an anode of the cell stack, and a diffuser disposed between the nozzle and the anode; a first contact disposed adjacent to the nozzle so as to face the diffuser; a second contact disposed at the diffuser so as to face the nozzle, wherein the second contact is disposed to contact the first contact when the nozzle and the diffuser are concentric with each other; and a concentricity analysis device configured to: detect a signal corresponding to contact or non-contact between the first contact and the second contact; and determine, based on the signal, whether the nozzle and the diffuser are concentric with each other.

An ejector for a fuel cell may comprise: a nozzle configured to eject hydrogen to an anode of the fuel cell, and a diffuser disposed between the nozzle and the anode; first contacts disposed adjacent to the nozzle; second contacts disposed at the diffuser, wherein each of the second contacts is disposed to be in contact a corresponding one of the first contacts when the nozzle is inserted in the diffuser and the nozzle and the diffuser are concentric with each other; and a sensor configured to: detect a signal generated based on the first contacts and the second contacts being in contact; and indicate, based on the signal, the nozzle is concentric with the diffuser.

These and other features and advantages are described in greater detail below.

### BRIEF DESCRIPTION OF THE DRAWINGS

The accompanying drawings, which are included to provide a further understanding of the disclosure and are incorporated in and constitute a part of this application, illustrate example(s) of the disclosure and together with the description serve to explain the principle of the disclosure. In the drawings:

FIG. 1 is a block diagram of a fuel cell apparatus;

FIG. 2 is a side-sectional view of an ejector according to an example;

FIG. 3A is a rear view of a nozzle, a first contact part, and a support part according to the example;

FIG. 3B is a front view of a diffuser and a second contact part according to the example;

FIG. 4 is a view schematically showing a state in which the first and second contact parts according to the example are in contact with each other;

FIG. 5A is a rear view of a nozzle, a first contact part, and a support part according to another example;

FIG. 5B is a front view of a diffuser, a second contact part, and a connection part according to another example;

FIG. 6 is a view schematically showing a state in which the first and second contact parts and the connection part according to the other example are in contact with each other;

FIG. 7A is a front view of a diffuser, a second contact part, and a connection part according to still another example; and

FIG. 7B is a view schematically showing a state in which the first and second contact parts and the connection part according to the still other example are in contact with each other.

### DETAILED DESCRIPTION

The present disclosure will now be described more fully hereinafter with reference to the accompanying drawings, in which various examples are shown. The examples, however, may be embodied in many different forms, and should not be construed as being limited to the examples set forth herein. Rather, these examples are provided so that this disclosure will be more thorough and complete, and will more fully convey the scope of the disclosure to those skilled in the art.

It will be understood that when an element is referred to as being “on” or “under” another element, it may be directly on/under the element, or one or more intervening elements may also be present.

When an element is referred to as being “on” or “under”, “under the element” as well as “on the element” may be included based on the element.

In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B. “One or more of A or B” is synonymous with “at least one of A or B” herein.

Throughout the present disclosure, references to components, units, or modules generally refer to items that logically can be grouped together to perform a function or group of related functions. Like reference numerals are generally intended to refer to the same or similar components. Components, units, and modules may be implemented in software, hardware or a combination of software and hardware. The components, units, modules, and/or functions described above may be implemented and/or performed by one or more processors. For examples, the components, units, and/or modules may include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The components, units, and/or modules may also include software control module(s) implemented with a processor or logic circuitry for example. The components, units, and/or modules may include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware. One or more storage type media may include any or all of the tangible memory of computers, processors, or the like, or associated modules thereof, such as various semiconductor memories, tape drives, disk drives and the like, which may provide non-transitory storage at any time for software programming.

The expressions such as “comprise”, “may comprise”, “include”, “may include”, “have”, “may have”, etc. as used herein are intended to mean the presence of a characteristic (e.g., function, operation, component, etc.) and do not exclude the presence of other additional characteristics. That is, these expressions should be understood as open-ended terms that encompass the possibility that other examples are included.

A singular expression used herein may include the meaning of the plural unless otherwise stated in the context, which also applies to the singular expression described in the claims.

The expression “based on” as used herein is intended to describe one or more factors that influence an act or operation of determining or deciding described in a phrase or sentence including that expression, and this expression does not exclude any additional factors that influence the act or operation of determining or deciding.

When it is described that a component (e.g., a first component) is “connected” or “coupled” to another component (e.g., a second component) as used herein, it may mean that the component is not only directly connected or coupled to another component, but also connected or coupled through yet another component (e.g., a third component).

Depending on the context, the expression “configured to” as used herein may have meanings such as “set to”, “with the ability to”, “modified to”, “made to”, “to be able to”, etc. This expression is not limited to the meaning of “specially designed in hardware to”. For example, a processor configured to perform a specific operation may refer to a generic purpose processor capable of performing the specific operation by executing software, or to a special purpose computer structured through programming to perform the specific operation.

Hereinafter, an example fuel cell apparatus (e.g., a fuel cell apparatus 100) will be described with reference to the accompanying drawings. The fuel cell apparatus 100 will be described using the Cartesian coordinate system (x-axis, y-axis, z-axis) for convenience of description, but may also be described using other coordinate systems. In the Cartesian coordinate system, the x-axis, the y-axis, and the z-axis are perpendicular to each other, but the examples are not limited thereto. That is, the x-axis, the y-axis, and the z-axis may intersect each other obliquely.

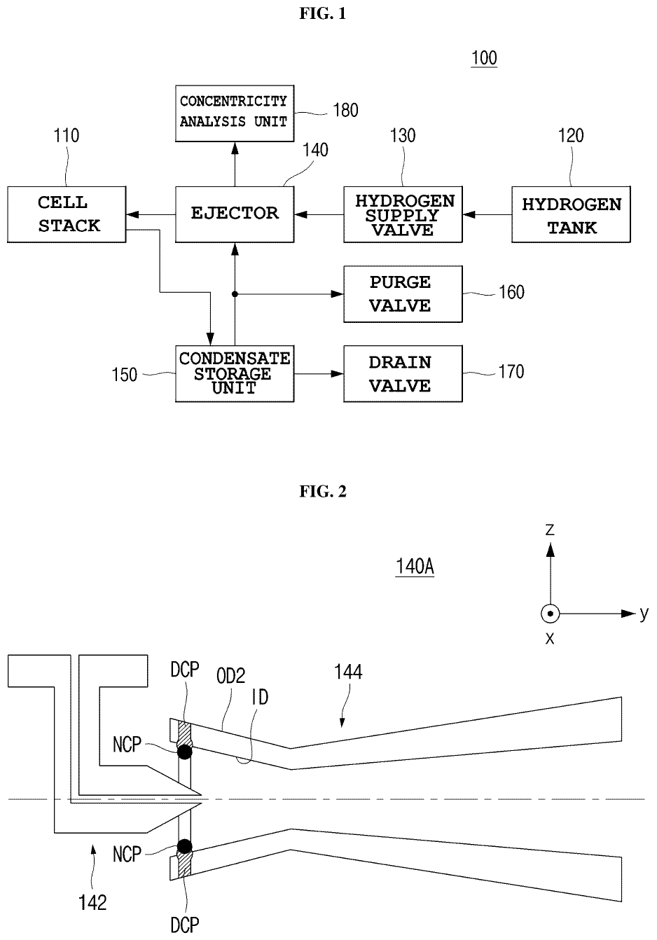

FIG. 1 is a block diagram of a fuel cell apparatus 100.

The fuel cell apparatus 100 may include a cell stack 110, a hydrogen tank 120, a hydrogen supply valve 130, an ejector 140, a condensate storage unit 150, a purge valve 160, and a drain valve 170. Also, or alternatively, the fuel cell apparatus 100 may include a concentricity analysis unit 180.

A fuel cell serves to generate power. A fuel cell may be, for example, a polymer electrolyte membrane fuel cell (or proton exchange membrane fuel cell) (PEMFC), which has been studied extensively as a power source for driving a fuel cell vehicle (hereinafter referred to as a “vehicle”) including the fuel cell apparatus 100. However, the examples are not limited to any specific form of the fuel cell.

The fuel cell may include a cell stack 110 and a current collector (e.g., a current-collecting terminal) (not shown).

If the fuel cell apparatus 100 is a fuel cell vehicle, the cell stack 110 may include a plurality of unit cells stacked in a forward direction (e.g., a heading direction and/or a travel direction) of the vehicle and/or in a direction intersecting the forward direction of the vehicle.

Hydrogen (or fuel) supplied from the hydrogen tank 120 may pass through the hydrogen supply valve 130 in an open state, enters a fuel electrode (anode) of the cell stack 110 through the ejector 140 that provides injection pressure. The hydrogen may undergo a reaction for generation of electricity. Thereafter, a portion of the hydrogen (or fuel) is recirculated to the fuel electrode (anode) of the cell stack 110, and/or the remaining portion thereof is discharged via the purge valve 160. This is called hydrogen purge. That is, during hydrogen purge, a portion of the hydrogen discharged from the cell stack 110 is recirculated to the fuel electrode (anode) of the cell stack 110 by operation of a hydrogen recirculation blower (not shown), and the remaining portion of the hydrogen is discharged to the outside through the purge valve 160.

When/if air supplied to an air electrode of the cell stack 110 moves along a flow path and reacts with hydrogen, condensate may be generated at the air electrode, etc., and may be stored in the condensate storage unit 150. The condensate stored in the condensate storage unit 150 may be discharged to the outside via the drain valve 170.

Hereinafter, the configuration and operation of the ejector according to the example will be described with reference to the accompanying drawings. In order to assist in understanding of the ejector of the example, the fuel cell apparatus 100 shown in FIG. 1 will be described by way of example. That is, an ejector 140A to be described below may correspond to an example of the ejector 140 shown in FIG. 1. However, the ejector to be described below may also be applied to a fuel cell apparatus configured differently from the fuel cell apparatus 100 shown in FIG. 1.

FIG. 2 is a side-sectional view of an ejector 140A according to an example.

The ejector 140A according to the example may include a nozzle 142 and a diffuser 144.

The ejector 140A may comprise a type of pump that ejects a compressed fluid through the nozzle 142 at a high speed to create a low pressure region around the nozzle 142, thereby suctioning a surrounding fluid and discharging the suctioned fluid. The nozzle 142 of the ejector 140A may be configured to eject a high-pressure primary fluid (hydrogen) at a high speed. The diffuser 144 of the ejector 140A may be configured to lower the speed of the fluid and increase the pressure of the fluid. The nozzle 142 may serve to eject hydrogen (e.g., fuel) to the anode of the cell stack 110. The diffuser 144 may be disposed between the nozzle 142 and the anode of the cell stack 110.

The ejector 140A (e.g., of fuel cell apparatus 100 according to the example) may include first contact parts NCP (may also be referred to as a first contact) and second contact parts DCP (may also be referred to as a second contact).

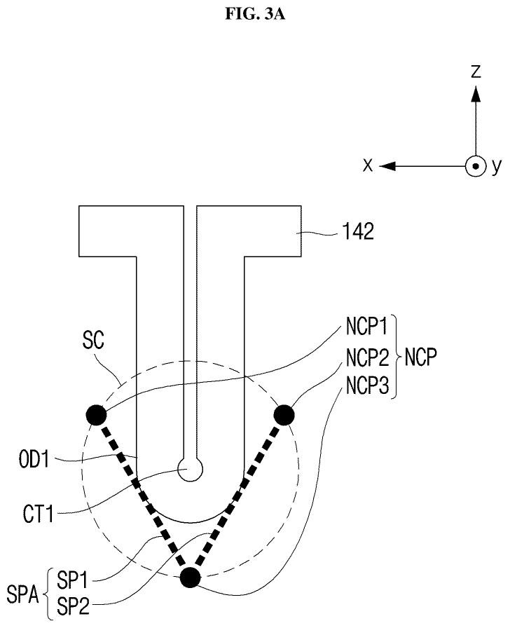

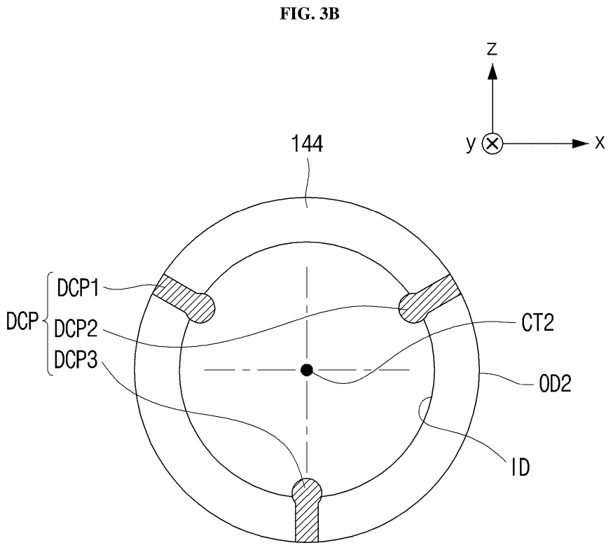

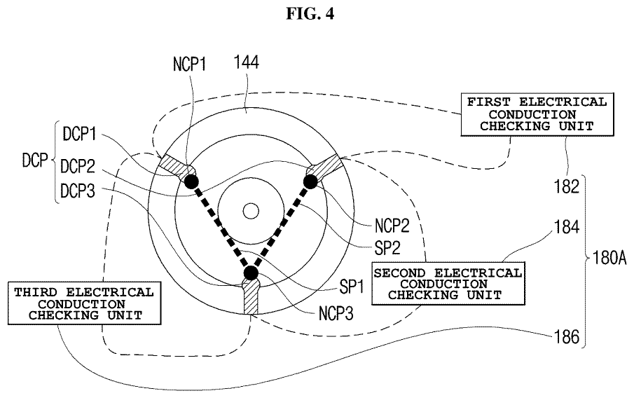

FIG. 3A is a rear view of the nozzle 142, a first contact part NCP, and a support part SPA (may also be referred to as a support) according to the example, FIG. 3B is a front view of the diffuser 144 and a second contact part DCP according to the example, and FIG. 4 is a view schematically showing a state in which the first and second contact parts NCP and DCP according to the example are in contact with each other.

The first contact part NCP may be disposed adjacent to the nozzle 142 so as to face the diffuser 144 in a y-axis direction. Here, the y-axis direction is a direction in which the nozzle 142 and the diffuser 144 are coupled to each other (as indicated throughout the figures). The second contact part DCP may be disposed at the diffuser 144 so as to face the nozzle 142 in the y-axis direction.

The concentricity analysis unit 180 may inspect contact or non-contact between the first contact part NCP and the second contact part DCP, and may determine, based on a result of the inspection, whether the nozzle 142 and the diffuser 144 are concentric with each other. For example, the concentricity analysis unit 180 may receive one or more signals indicating contact or no contact (e.g., electrical and/or conductivity signals indicating contact or no contact) between the first contact part NCP and the second contact part DCP, and determine based on the one or more signals whether the nozzle 142 and diffuser 144 are concentric with each other.

The first contact part NCP and the second contact part DCP may be configured and positioned relative to the nozzle 142 and the diffuser 144 such that the first contact part NCP and the second contact part DCP contact with each other when/if the nozzle 142 and the diffuser 144 are in a concentric state (e.g., in which a first center CT1 of the nozzle 142 and a second center CT2 of the diffuser 144 are aligned with each other in the y-axis direction). According to the example, the first contact part NCP and the second contact part DCP may have one or more of the following configurations in order to enable inspection of contact or non-contact between the first contact part NCP and the second contact part DCP and determination as to whether the first and second centers CT1 and CT2 are aligned with each other.

According to an example, the first contact part NCP may include a plurality of nozzle contact parts (may also be referred to as a plurality of nozzle contacts) disposed adjacent to an outer diameter portion OD1 of the nozzle 142. The second contact part DCP may include a plurality of diffuser contact parts (may also be referred to as a plurality of diffuser contacts). Each of the plurality of diffuser contact parts may include an inner portion that is located inside the diffuser 144 so as to be electrically contactable with a corresponding one of the plurality of nozzle contact parts, an outer portion that is exposed outside the diffuser 144, and an intermediate portion that penetrates the diffuser 144 from an inner diameter portion ID of the diffuser 144 to an outer diameter portion OD2 of the diffuser 144 while interconnecting the inner portion and the outer portion.

As an illustrative example, the second contact part may comprise three diffuser contact parts DCP1, DCP2, and DCP 3. Each of the first to third diffuser contact parts DCP1, DCP2, and DCP3 may be formed such that the inner portion thereof is located on the inner diameter portion ID of the diffuser 144 and the outer portion thereof protrudes outward from the outer diameter portion OD2 of the diffuser 144. For example, each of the first to third diffuser contact parts DCP1, DCP2, and DCP3 may be formed in a bar shape.

The plurality of nozzle contact parts may include first to third nozzle contact parts NCP1, NCP2, and NCP3 disposed so as to be spaced apart from each other. The plurality of diffuser contact parts may include first to third diffuser contact parts DCP1, DCP2, and DCP3 disposed so as to be spaced apart from each other in one-to-one correspondence with the first to third nozzle contact parts NCP1, NCP2, and NCP3. The positions of the plurality of nozzle contact parts may be varied depending on the size of the nozzle 142, for example.

In order to enable inspection of contact or non-contact between the first to third nozzle contact parts NCP1, NCP2, and NCP3 and the first to third diffuser contact parts DCP1, DCP2, and DCP3 and determination as to whether the nozzle 142 and the diffuser 144 are concentric with each other, intervals between the first to third nozzle contact parts NCP1, NCP2, and NCP3 may correspond to (e.g. be the same as, be identical to) intervals between the first to third diffuser contact parts DCP1, DCP2, and DCP3. Positions of the first to third nozzle contact parts NCP1, NCP2, and NCP3 and positions the first to third diffuser contact parts DCP1, DCP2, and DCP3 may be selected/designed so that the nozzle 142 and the diffuser 144 are concentric with each other when the first to third nozzle contact parts NCP1, NCP2, and NCP3 and the first to third diffuser contact parts DCP1, DCP2, and DCP3 are in contact with each other in one-to-one correspondence.

For example, as shown in FIG. 3A, the first to third nozzle contact parts NCP1, NCP2, and NCP3 may be disposed so as to be spaced apart from each other on the circumference of an imaginary circle SC that has a center coinciding with the center CT1 of the nozzle 142. The first to third nozzle contact parts NCP1, NCP2, and NCP3 may be spaced apart from the outer diameter portion OD1 of the nozzle 142.

As shown in FIG. 3B, the first to third diffuser contact parts DCP1, DCP2, and DCP3 may be disposed so as to be spaced apart from each other on a circumference that is defined by the inner diameter portion ID of the diffuser 144, which is centered at the center CT2 of the diffuser 144.

The fuel cell apparatus 100 according to the example may further include a support part SPA (e.g., a support). The support part SPA may be mounted to the nozzle 142 to interconnect and/or support (e.g., position/maintain relative positions of) the plurality of nozzle contact parts (e.g., the first to third nozzle contact parts NCP1, NCP2, and NCP3).

According to an example, the support part SPA may include first and second support parts SP1 and SP2 (e.g., first and second supports). The first support part SP1 may electrically interconnect and support the first nozzle contact part NCP1 and the third nozzle contact part NCP3, and the second support part SP2 may electrically interconnect and support the second nozzle contact part NCP2 and the third nozzle contact part NCP3.

If the nozzle 142 (e.g., shown in FIG. 3A) and the diffuser 144 (e.g., as shown in FIG. 3B) are concentric with each other, the first contact part NCP may be in contact with the second contact part DCP (e.g., as shown in FIG. 4).

A concentricity analysis unit 180A (e.g., alternately referred to as a concentricity analyzer, a concentricity analysis device having at least one electrical conductivity sensor) (e.g., as an example of the concentricity analysis unit 180 shown in FIG. 1), may include first to third electrical conduction checking units 182, 184, and 186. For example, at least one of the first to third electrical conduction checking units 182, 184, 186 may comprise one or more sensors (e.g., one or more electrical conductivity sensors) configured to sense electrical conduction/conductivity (e.g., voltmeter, ammeter, etc.).

If the first contact part NCP and the second contact part DCP are in contact with each other, the first nozzle contact part NCP1 and the first diffuser contact part DCP1 may be in contact with each other, the second nozzle contact part NCP2 and the second diffuser contact part DCP2 may be in contact with each other, and the third nozzle contact part NCP3 and the third diffuser contact part DCP3 may be in contact with each other. If the first nozzle contact part NCP1 and the first diffuser contact part DCP1 are in contact with each other, if the second nozzle contact part NCP2 and the second diffuser contact part DCP2 are in contact with each other, and if the third nozzle contact part NCP3 and the third diffuser contact part DCP3 are in contact with each other, a closed circuit may be formed through which current can flow. The first to third electrical conduction checking units 182, 184, and 186 may detect a current flowing through the closed circuit and/or that a current can flow through the circuit. As such, based on the detected current flow/conductivity, it may be determined that the first contact part NCP and the second contact part DCP are in an electrically conductive state, which may indicate that the nozzle 142 and the diffuser 144 are concentric with each other.

The first electrical conduction checking unit 182 may be connected to (e.g., configured to check electrical conduction between) the first diffuser contact part DCP1 and the second diffuser contact part DCP2.

The second electrical conduction checking unit 184 may be connected to (e.g., configured to check electrical conduction between) the second diffuser contact part DCP2 and the third diffuser contact part DCP3.

The third electrical conduction checking unit 186 may be connected to (e.g., configured to check electrical conduction between) the first diffuser contact part DCP1 and the third diffuser contact part DCP3.

Also, or alternatively, as shown in FIG. 4, if the first nozzle contact part NCP1 and the first diffuser contact part DCP1 are in contact with each other, if the second nozzle contact part NCP2 and the second diffuser contact part DCP2 are in contact with each other, and if both the first support part SP1 and the second support part SP2 are conductive, a path through which current flows is formed may be formed if the first electrical conduction checking unit 182 is connected to the first and second diffuser contact parts DCP1 and DCP2, for example. The first electrical conduction checking unit 182 may determine that the nozzle 142 and the diffuser 144 are concentric with each other an indication of the conductive path being formed.

Also, or alternatively, referring to FIG. 4, if the first contact part NCP and the second contact part DCP are in contact with each other, the second nozzle contact part NCP2 and the second diffuser contact part DCP2 may be in contact with each other, the third nozzle contact part NCP3 and the third diffuser contact part DCP3 may be in contact with each other. If the second support part SP2 is conductive, when the second electrical conduction checking unit 184 is connected to the second and third diffuser contact parts DCP2 and DCP3, a path through which current flows may be formed. In this case, the second electrical conduction checking unit 184 may determine (e.g., based on detected current and/or conductivity) that the nozzle 142 and the diffuser 144 are concentric with each other.

Also, or alternatively, referring to FIG. 4, if the first contact part NCP and the second contact part DCP are in contact with each other, the first nozzle contact part NCP1 and the first diffuser contact part DCP1 may be in contact with each other, and the third nozzle contact part NCP3 and the third diffuser contact part DCP3 may be in contact with each other. If the first support part SP1 is conductive, when the third electrical conduction checking unit 186 is connected to the first and third diffuser contact parts DCP1 and DCP3, a path through which current flows may be formed. In this case, the third electrical conduction checking unit 186 may determine (e.g., based on detected current and/or conductivity) that the nozzle 142 and the diffuser 144 are concentric with each other.

In this way, the first electrical conduction checking unit 182 may check whether the first and second nozzle contact parts NCP1 and NCP2 are in contact with the first and second diffuser contact parts DCP1 and DCP2 (e.g., contact indicating the nozzle 142 and the diffuser 144 are concentric with each other). The second electrical conduction checking unit 184 may check whether the second and third nozzle contact parts NCP2 and NCP3 are in contact with the second and third diffuser contact parts DCP2 and DCP3. The third electrical conduction checking unit 186 may check whether the first and third nozzle contact parts NCP1 and NCP3 are in contact with the first and third diffuser contact parts DCP1 and DCP3.

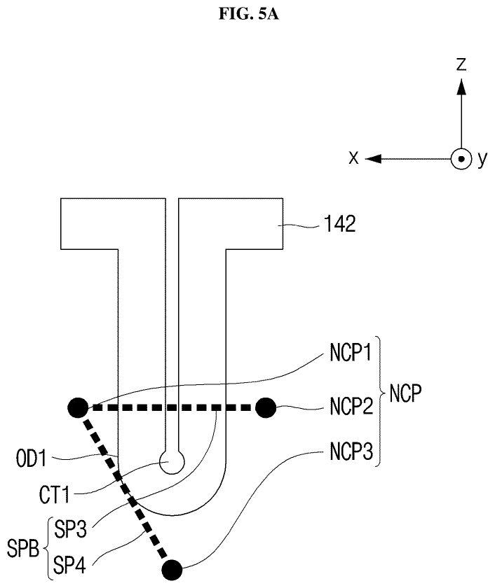

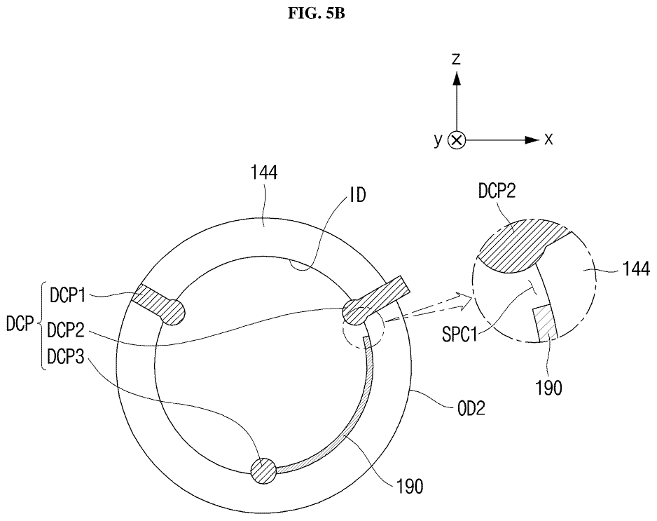

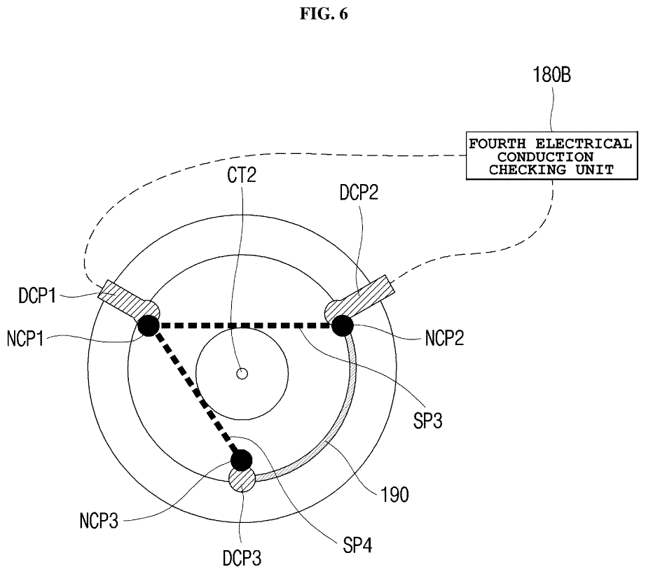

FIG. 5A is a rear view of the nozzle 142, a first contact part NCP, and a support part SPB according to another example, FIG. 5B is a front view of the diffuser 144, a second contact part DCP, and a connection part 190 according to another example, and FIG. 6 is a view schematically showing a state in which the first and second contact parts NCP and DCP and the connection part 190 according to the other example are in contact with each other.

The example shown in FIGS. 5A to 6 is identical to the example shown in FIGS. 3A to 4, except that the support part SPB is configured differently than the support part SPA and the connection part 190 (e.g., connector) is further included. Therefore, duplicate descriptions of the same parts will be omitted, and only different parts will be described.

According to the example, the support part SPB (e.g., support) may include third and fourth support parts SP3 and SP4. The third support part SP3 may electrically insulate the first nozzle contact part NCP1 and the second nozzle contact part NCP2 from each other and/or may support (e.g., position/maintain relative positions of) the first and second nozzle contact parts NCP1 and NCP2. The fourth support part SP4 may electrically interconnect and/or support the first nozzle contact part NCP1 and the third nozzle contact part NCP3.

The support part SPA or SPB may be configured to not be removed after assembly (e.g., onto the nozzle) in order to support the nozzle contact parts, and may be implemented so as not to affect the recirculation performance. For example, the support part SPA or SPB may be mounted on the outer side of the nozzle 142.

According to the other example, the fuel cell apparatus 100 may further include a connection part 190. The connection part 190 may be disposed on the inner diameter portion ID of the diffuser 144. The connection part 190 may be electrically connected to the third diffuser contact part DCP3 and spaced apart from the second diffuser contact part DCP2 by a first predetermined space SPC1 (e.g., having a predetermined distance between the second diffuser contact part DCP2 and the connection part 190). In this case, when/if the nozzle 142 and the diffuser 144 are coupled to each other, the second nozzle contact part NCP2 may be disposed in the first predetermined space SPC1 between the second diffuser contact part DCP2 and the connection part 190, thereby electrically interconnecting the second diffuser contact part DCP2 and the connection part 190.

The concentricity analysis unit 180 may include a fourth electrical conduction checking unit 180B. The fourth electrical conduction checking unit 180B may correspond to another example of the concentricity analysis unit 180 shown in FIG. 1.

The fourth electrical conduction checking unit 180B may be connected to the first diffuser contact part DCP1 and the second diffuser contact part DCP2 and configured to check electrical conduction. If the nozzle 142 and the diffuser 144 are concentric with each other, the first nozzle contact part NCP1 and the first diffuser contact part DCP1 may be in contact with each other, the second nozzle contact part NCP2 may be disposed in the first predetermined space SPC1 to electrically interconnect the second diffuser contact part DCP2 and the connection part 190, and the third nozzle contact part NCP3 and the third diffuser contact part DCP3 may be in contact with each other. If the first nozzle contact part NCP1 and the first diffuser contact part DCP1 are in contact with each other, if the second nozzle contact part NCP2 is disposed in the first predetermined space SPC1 to electrically interconnect the second diffuser contact part DCP2 and the connection part 190, and if the third nozzle contact part NCP3 and the third diffuser contact part DCP3 are in contact with each other, a closed circuit through which current flows may be formed. The fourth electrical conduction checking unit 180B may detect said current and/or conductivity and therefore determine that the first contact part NCP and the second contact part DCP are in an electrically conductive state. Based on the first contact part NCP and the second contact part DCP being detected to be in an electrically conductive state, it may be determined that the nozzle 142 and the diffuser 144 are concentric with each other.

As shown in FIG. 6, If the nozzle 142 and the diffuser 144 are concentric with each other, the first nozzle contact part NCP1 and the first diffuser contact part DCP1 may be in contact with each other, and the second nozzle contact part NCP2, the second diffuser contact part DCP2, and the connection part 190 may be in contact with each other. If the first nozzle contact part NCP1 and the first diffuser contact part DCP1 are in contact with each other, if the second nozzle contact part NCP2, the second diffuser contact part DCP2, and the connection part 190 are in contact with each other, and if the fourth support part SP4 is conductive, although the third support part SP3 is insulative, the first and second diffuser contact parts DCP1 and DCP2 may be connected to each other via the connection part 190 and the fourth support part SP4 when/if the third nozzle contact part NCP3 and the third diffuser contact part DCP3 are in contact with each other. In this way, if the fourth electrical conduction checking unit 180B is connected to the first and second diffuser contact parts DCP1 and DCP2, such that a path through which current flows is formed, the fourth electrical conduction checking unit 180B may determine, based on the detected current/conductivity, that the nozzle 142 and the diffuser 144 are concentric with each other.

The concentricity analysis unit 180A and/or 180B may more accurately determine whether the nozzle 142 and the diffuser 144 are concentric with each other by checking electrical conduction at least once. In addition, if the concentricity analysis unit 180A or 180B determines that the current state is not an electrically conductive state (e.g., current and/or conductivity below a threshold), it may be determined that the nozzle 142 and the diffuser 144 are not concentric with each other.

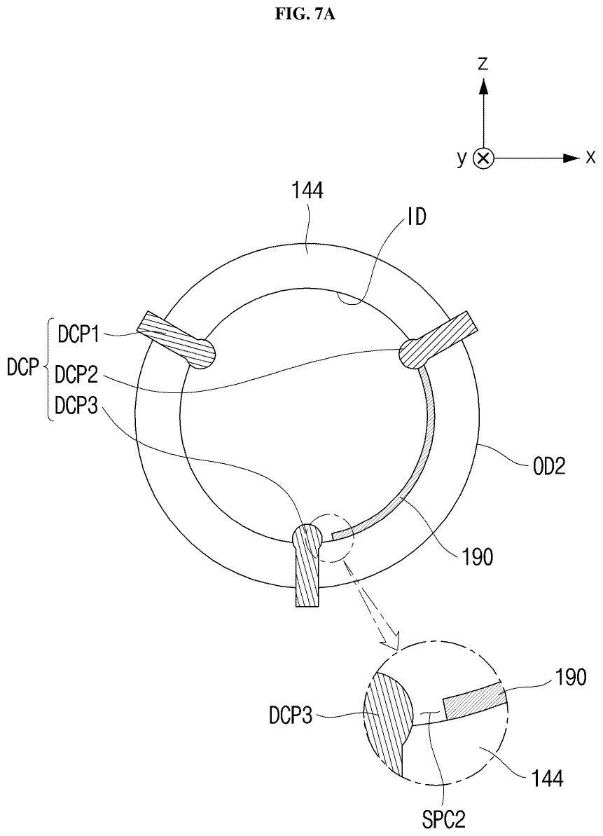

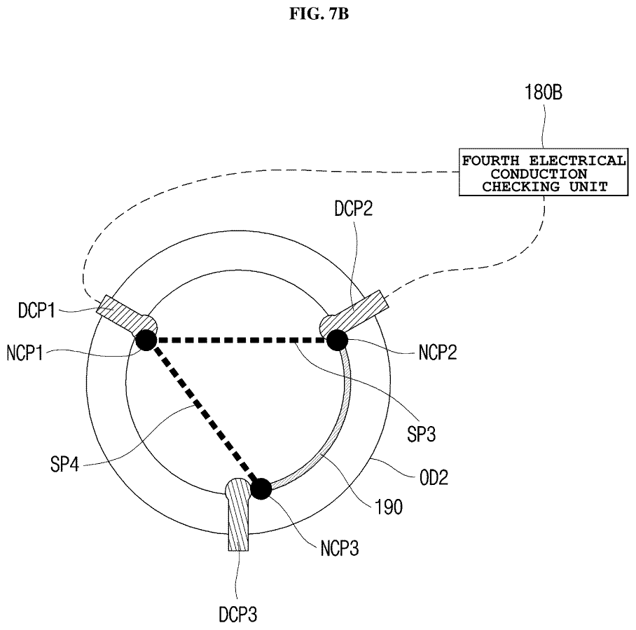

FIG. 7A is a front view of the diffuser 144, a second contact part DCP, and a connection part 190 according to still another example, and FIG. 7B is a view schematically showing a state in which the first and second contact parts NCP and DCP and the connection part 190 according to the example are in contact with each other.

The fuel cell apparatus according to the example shown in FIGS. 7A and 7B corresponds to the fuel cell apparatus according to the other example shown in FIGS. 5A to 6, except that the connection part 190 is disposed differently. Duplicate descriptions of the same parts will be omitted, and only different parts will be described.

Unlike the connection part 190 shown in FIGS. 5B and 6, the connection part 190 shown in FIG. 7B may be disposed on the inner diameter portion ID of the diffuser 144 while being electrically connected to the second diffuser contact part DCP2 and spaced apart from the third diffuser contact part DCP3 with a second predetermined space SPC2 therebetween (e.g., having a predetermined distance between the third diffuser contact part DCP3 and the connection part 190). In this case, the third nozzle contact part NCP3 may be disposed in the second predetermined space SPC2 between the third diffuser contact part DCP3 and the connection part 190 (e.g., if the diffuser 144 and the nozzle 142 are concentric with each other), thereby electrically interconnecting the third diffuser contact part DCP3 and the connection part 190.

As shown in FIGS. 5A to 7B, when/if the second or third nozzle contact part NCP2 or NCP3 is disposed in the first or second predetermined space SPC1 (e.g., FIG. 6) or SPC2 (e.g., FIG. 7B), the second diffuser contact part DCP2 or the third diffuser contact part DCP3 is connected to the connection part 190. In this way, a kind of switching operation may be performed (e.g., the NCP2 or NCP3 act as switches to close the circuit when so disposed).

The first and second contact parts NCP and DCP and the support parts SPA and SPB described above may be components of (e.g., attached to) the ejector 140 and/or may be components of (e.g., attached to) the fuel cell apparatus 100. The configuration shown in FIG. 1 corresponds to the configuration in which the first and second contact parts NCP and DCP and the support parts SPA and SPB are components of the ejector 140.

According to the example, it is possible to easily check the concentricity between the nozzle 142 and the diffuser 144, which constitute the ejector 140, after assembling the parts.

Each of the above-described first to fourth support parts SP1, SP2, SP3, and SP4 may be formed in a strip shape. However, the examples are not limited to any specific shape of the first to fourth support parts SP1, SP2, SP3, and SP4, so long as they support (e.g., maintain a position) of the disclosed components and/or have the conductive/electrical properties disclosed herein.

In the fuel cell apparatus 100 according to the example, the concentricity between the nozzle 142 and the diffuser 144, which constitute the ejector 140, may be checked without cutting parts. Further, since the concentricity of the ejector 140 is capable of being checked at the stage of inspection before shipment of parts, parts having further improved recirculation performance may be supplied. Furthermore, since variation in the recirculation performance of the ejector 140 is reduced, the reliability of the performance of the fuel cell apparatus 100 may be assured.

The fuel cell apparatus 100 according to the example described above may be applied to vehicles, aircraft, ships, stationary power generation systems, etc., but the disclosure is not limited thereto.

A fuel cell apparatus is provided that substantially obviates one or more problems due to limitations and disadvantages of the related art. The fuel cell apparatus is capable of checking the concentricity between a nozzle and a diffuser. The objectives to be accomplished by the present disclosure are not limited to the above-mentioned objectives, and other objectives not mentioned herein will be clearly understood by those skilled in the art from the following description.

Additional advantages, objectives, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

A fuel cell apparatus according to an example may include a cell stack including a plurality of unit cells stacked one above another, an ejector including a nozzle configured to eject hydrogen to an anode of the cell stack and a diffuser disposed between the nozzle and the anode, a first contact part disposed adjacent to the nozzle so as to face the diffuser, a second contact part disposed at the diffuser so as to face the nozzle, and a concentricity analysis unit configured to inspect contact or non-contact between the first contact part and the second contact part and to determine, based on a result of inspection, whether the nozzle and the diffuser are concentric with each other.

In an example, the first contact part may include a plurality of nozzle contact parts disposed adjacent to an outer diameter portion of the nozzle.

In an example, the fuel cell apparatus may further include a support part mounted to the nozzle to interconnect and support the plurality of nozzle contact parts.

In an example, the second contact part may include a plurality of diffuser contact parts configured to be electrically contactable with corresponding ones of the plurality of nozzle contact parts inside the diffuser and extending so as to protrude outside the diffuser.

In an example, the plurality of nozzle contact parts may include first to third nozzle contact parts disposed so as to be spaced apart from each other, and the plurality of diffuser contact parts may include first to third diffuser contact parts disposed so as to be spaced apart from each other in one-to-one correspondence with the first to third nozzle contact parts.

In an example, the support part may include a first support part configured to electrically interconnect and support the first nozzle contact part and the third nozzle contact part and a second support part configured to electrically interconnect and support the second nozzle contact part and the third nozzle contact part.

In an example, the concentricity analysis unit may include a first electrical conduction checking unit connected to the first diffuser contact part and the second diffuser contact part to check electrical conduction, a second electrical conduction checking unit connected to the second diffuser contact part and the third diffuser contact part to check electrical conduction, and a third electrical conduction checking unit connected to the first diffuser contact part and the third diffuser contact part to check electrical conduction.

In an example, the support part may include a third support part configured to electrically insulate the first nozzle contact part and the second nozzle contact part from each other and to support the first and second nozzle contact parts and a fourth support part configured to electrically interconnect and support the first nozzle contact part and the third nozzle contact part.

In an example, the fuel cell apparatus may further include a first connection part disposed on an inner diameter portion of the diffuser while being electrically connected to the third diffuser contact part and spaced apart from the second diffuser contact part with a first predetermined space therebetween, and the second nozzle contact part may be disposed in the first predetermined space between the second diffuser contact part and the first connection part.

In an example, the fuel cell apparatus may further include a second connection part disposed on an inner diameter portion of the diffuser while being electrically connected to the second diffuser contact part and spaced apart from the third diffuser contact part with a second predetermined space therebetween, and the third nozzle contact part may be disposed in the second predetermined space between the third diffuser contact part and the second connection part.

In an example, the concentricity analysis unit may further include a fourth electrical conduction checking unit connected to the first diffuser contact part and the second diffuser contact part to check electrical conduction.

It is to be understood that both the general and detailed descriptions herein are exemplary and explanatory and are intended to provide further explanation of the disclosure as claimed.

As is apparent from the present description, a fuel cell apparatus, according to the disclosure, allows for checking the concentricity between a nozzle and a diffuser, which constitute an ejector, without cutting parts. Further, since the concentricity of the ejector is capable of being checked at the stage of inspection before shipment of parts, it is possible to supply parts having further improved recirculation performance and to reduce variation in the recirculation performance of the ejector, thereby ensuring high reliability of the performance of the fuel cell apparatus.

However, the effects achievable through the disclosure are not limited to the effects mentioned herein, and other effects not mentioned herein will be clearly understood by those skilled in the art from the present description.

The examples described herein may be combined with each other without departing from the scope of the present disclosure unless they are incompatible with each other.

In addition, for any element or process that is not described in detail in any of the various examples, reference may be made to the description of an element or a process having the same reference numeral in another example, unless otherwise specified.

While the present disclosure has been particularly shown and described with reference to exemplary examples thereof, these examples are only proposed for illustrative purposes, and do not restrict the present disclosure, and it will be apparent to those skilled in the art that various changes in form and detail may be made without departing from the essential characteristics of the examples set forth herein. For example, respective configurations set forth in the examples may be modified and applied. Further, differences in such modifications and applications should be construed as falling within the scope of the present disclosure as defined by the appended claims.

What is claimed is:

1. A fuel cell apparatus, comprising:
a cell stack comprising a plurality of unit cells;
an ejector comprising:
a nozzle configured to eject hydrogen to an anode of the cell stack, and
a diffuser disposed between the nozzle and the anode;
a first contact disposed adjacent to the nozzle so as to face the diffuser;
a second contact disposed at the diffuser so as to face the nozzle, wherein the second contact is disposed to contact the first contact when the nozzle and the diffuser are concentric with each other; and
a concentricity analysis device configured to:
detect a signal corresponding to contact or non-contact between the first contact and the second contact; and
determine, based on the signal, whether the nozzle and the diffuser are concentric with each other.

2. The fuel cell apparatus according to claim 1, wherein the first contact comprises a plurality of nozzle contacts disposed adjacent to an outer diameter portion of the nozzle.

3. The fuel cell apparatus according to claim 2, further comprising a support mounted to the nozzle and configured to interconnect and support the plurality of nozzle contacts.

4. The fuel cell apparatus according to claim 3, wherein the second contact comprises a plurality of diffuser contacts configured to electrically contact, inside the diffuser, the plurality of nozzle contacts, wherein the plurality of diffuser contacts are electrically contactable from outside the diffuser.

5. The fuel cell apparatus according to claim 4, wherein the plurality of nozzle contacts comprises first to third nozzle contacts spaced apart from each other, and
wherein the plurality of diffuser contacts comprises first to third diffuser contacts disposed spaced apart from each other in one-to-one correspondence with the first to third nozzle contacts.

6. The fuel cell apparatus according to claim 5, wherein the support comprises:
a first support part configured to electrically interconnect and support the first nozzle contact and the third nozzle contact; and
a second support part configured to electrically interconnect and support the second nozzle contact and the third nozzle contact.

7. The fuel cell apparatus according to claim 6, wherein the concentricity analysis device comprises:
a first electrical conduction sensor configured to be connected to the first diffuser contact and the second diffuser contact;
a second electrical conduction sensor configured to be connected to the second diffuser contact and the third diffuser contact; and
a third electrical conduction sensor connected to the first diffuser contact and the third diffuser contact.

8. The fuel cell apparatus according to claim 5, wherein the support comprises:
a third support part configured to electrically insulate the first nozzle contact from the second nozzle contact and to support the first nozzle contact and the second nozzle contact; and
a fourth support part configured to electrically interconnect and support the first nozzle contact and the third nozzle contact.

9. The fuel cell apparatus according to claim 8, further comprising a conductive connection disposed on an inner diameter portion of the diffuser to be electrically connected to the third diffuser contact and spaced apart from the second diffuser contact by a space,
wherein the second nozzle contact is configured to be, when the nozzle is concentric with the diffuser, disposed in the space so as to electrically connect the second diffuser contact and the conductive connection.

10. The fuel cell apparatus according to claim 8, further comprising a conductive connection disposed on an inner diameter portion of the diffuser to be electrically connected to the second diffuser contact and spaced apart from the third diffuser contact by a space,
wherein the third nozzle contact is configured to be, when the nozzle is concentric with the diffuser, disposed in the space so as to electrically connect the third diffuser contact and the conductive connection.

11. The fuel cell apparatus according to claim 10, wherein the concentricity analysis device further comprises a fourth electrical conduction sensor configured to be connected to the first diffuser contact and the second diffuser contact.

12. An ejector for a fuel cell, the ejector comprising:
a nozzle configured to eject hydrogen to an anode of the fuel cell, and
a diffuser disposed between the nozzle and the anode;
first contacts disposed adjacent to the nozzle;
second contacts disposed at the diffuser, wherein each of the second contacts is disposed to be in contact a corresponding one of the first contacts when the nozzle is inserted in the diffuser and the nozzle and the diffuser are concentric with each other; and
a sensor configured to:
detect a signal generated based on the first contacts and the second contacts being in contact; and
indicate, based on the signal, the nozzle is concentric with the diffuser.

13. The ejector of claim 12, wherein the first contacts and the second contacts are electrically conductive, and wherein the signal comprises an electric signal.

14. The ejector of claim 13, wherein each of the second contacts comprises a first end configured to contact a corresponding one of the first contacts, and a second end exposed at an outer side of the diffuser.

15. The ejector of claim 12, wherein the sensor comprises a conductivity sensor configured to detect a current that flows through a circuit closed based on the first contacts being in contact with the second contacts, wherein the signal is based on the detected current.

16. The ejector of claim 12, wherein the first contacts comprise a plurality of nozzle contacts and wherein the second contacts comprise a plurality of diffuser contacts positioned to each contact a respective nozzle contact of the plurality of nozzle contacts when the nozzle is inserted in and concentric with the diffuser.

17. The ejector of claim 16, wherein the plurality of nozzle contacts are spaced apart from each other and comprise a first nozzle contact, a second nozzle contact, and a third nozzle contact, and
wherein the plurality of diffuser contacts are spaced apart from each other and comprise a first diffuser contact corresponding to the first nozzle contact, a second diffuser contact corresponding to the second nozzle contact, and a third diffuser contact corresponding to the third nozzle contact.

18. The ejector according to claim 17, further comprising:
a first support configured to electrically interconnect and support the first nozzle contact and the third nozzle contact; and
a second support configured to electrically interconnect and support the second nozzle contact and the third nozzle contact.

19. The ejector according to claim 18, wherein the sensor is configured to determine whether the nozzle is concentric with the diffuser by receiving the signal from one or more of:
a first electrical conductivity sensor configured to be connected to the first diffuser contact and the second diffuser contact;
a second electrical conductivity sensor configured to be connected to the second diffuser contact and the third diffuser contact; and
a third electrical conductivity sensor connected to the first diffuser contact and the third diffuser contact.

20. The ejector of claim 12, wherein a first contact of the first contacts is configured to, when the nozzle is inserted in and concentric with the diffuser, electrically connect a second contact of the second contacts to an electrically conductive connection disposed inside the diffuser.
